(19) United States
(12) Patent Application Publication
(10) Pub. No.: US 2006/0163234 A1
(43) Pub. Date: Jul. 27, 2006

(54) Resistive film on aluminum tube

(75) Inventors: H. Marion Warren, Vilas, NC (US); Wilson R. Hayworth, Blowing Rock, NC (US); M. Shane Hawthorne, Boone, NC (US)

Correspondence Address: KENNEDY COVINGTON LOBDELL & HICKMAN, LLP, 214 N. TRYON STREET, HEARST TOWER, 47TH FLOOR, CHARLOTTE, NC, 28202, US

(73) Assignee: International Resistive Company, Boone, NC (US)

(21) Appl. No.: 11/390,725

(22) Filed: Mar. 28, 2006

Related U.S. Application Data
(62) Division of application No. 10/871,117, filed on Jun. 18, 2004.
(60) Provisional application No. 60/512,731, filed on Oct. 20, 2003.

(51) Int. Cl. B60L 1/02

(52) U.S. Cl. 219/202

(57) ABSTRACT

A tubular resistor assembly for use in electrical circuits for controlling automotive accessories, including a tubular aluminum or other metal substrate having watertight walls and open ends for connection to a fluid-carrying system, a resistor of a predetermined magnitude disposed on the tubular metal substrate. A control circuit, incorporating the resistor, controls the operation of one or more automotive accessory. The assembly may be used to intentionally heat a fluid passing through the tubular substrate, the fluid may be used to carry excess heat away from the resistor, or both. Multiple resistive elements may be included for multiple levels of control of such accessories as headlights, fan assemblies, and the like.

### CROSS-REFERENCE TO RELATED APPLICATION

This application is entitled to the benefit of, and claims priority to provisional U.S. patent application Ser. No. 60/512,731filed Oct. 20, 2003and entitled “RESISTIVE FILM ON ALUMINUM TUBE,” the entirety of which is incorporated herein by reference.

### FIELD OF THE PRESENT INVENTION

The present invention relates generally to automotive electrical systems, and, in particular, to tubular resistor assemblies for transferring heat to a fluid flowing therethrough and circuits incorporating such assemblies.

### BACKGROUND

Thick film circuits distributed on stainless steel and other metallic substrates are believed to have been in use since the 1940's. As is well known, “thick film” circuits are those in which conductive material is applied to a substrate via screen printing and similar techniques, whereby the material, in the form of a paste, is forced through a pre-patterned mesh or stencil.

The substrates on which thick film circuits have traditionally been constructed were planar in shape. More recently, however, thick film circuits have been applied to tubular structures formed from stainless steel or ceramic tubes. Such a structure provides a convenient means of exchanging heat between the circuit and a fluid (which may be a liquid or a gas) pumped or otherwise forced through the tube, and is often more space-efficient than a corresponding planar structure. When the circuit is used specifically to generate heat in a resistive element, the heat may be applied to intentionally elevate the temperature of the fluid. For example, U.S. Pat. No. 5,973,296to Juliano et al., assigned to Watlow Electric Manufacturing Company (the “Watlow”), and U.S. Pat. No. 6,575,729to Godwin et al., assigned to Husky Injection Molding Systems Ltd., each disclose a tubular thick film device for heating a nozzle in an injection molding system. In each case, the tubular substrate is apparently formed from stainless steel or the like, or from a ceramic material such as alumina or aluminum nitride. Unfortunately, stainless steel is considered to be too heavy for many applications, such as in motor vehicles where lighter weight is often an important design goal, and the heat transfer rate offered by steel are not as high as would be desired. Ceramics, on the other hand, are not malleable and cannot withstand additional forming once the general tubular structure is formed. In fact, ceramics are quite brittle and are easily broken or shattered. Moreover, ceramics do not transfer heat as rapidly as many metals.

One lightweight metal material frequently utilized in automotive applications is aluminum. However, no known applications utilize tubular aluminum substrates to exchange heat between a resistive element and a fluid flowing therethrough, most likely because the use of tubular substrate technology has been mostly limited to heating water in buildings and other permanent structures. Unfortunately, the breakdown voltage of anodized aluminum is too low for use with typical building power supplies, which in the United States typically operate at 110 volts. Further, aluminum is unsafe for carrying drinking water, and thus such technology often may not be used to heat a building's water supply.

However, at least one aluminum device has been developed for electrically heating a coolant fluid in a motor vehicle has been developed by Autopal, a subsidiary of Visteon Corporation located in Prague, Czech Republic. In the Autopal device, a series of three cartridge heaters or glow plugs are inserted through the wall of a tubular structure that is placed inline in an automobile's coolant system. An electrical harness routes individually controllable wires to the cartridge heaters, enabling each cartridge heater to be individually heated through the application of an electrical current thereto. As the temperature of each cartridge heater rises, the heat radiating from the cartridge heater is transferred to the coolant fluid flowing through the structure, and from there to the engine itself, disposed just downstream from the device. Advantageously, by activating the electrical harness, the device may thus be used to warm the engine itself up, which may be useful during “cold start” conditions or the like. Further, the amount of heat thus generated may be controlled by controlling the number of cartridge heaters that are activated at any given time.

Unfortunately, the Autopal device suffers from a number of deficiencies. First, the device occupies considerable space, and is complicated to manufacture and install. The arrangement may also be more likely to fail. In addition, the use of the cartridge heaters creates a very high power density at the point of heating, which can cause localized steam effects in the coolant or can boil out the coolant into a sludge which creates circulation issues.

Further, of particular significance, the Autopal device is convenient only for heating the coolant fluid, and is ill-suited for use as a resistor of a stable value in an electrical circuit that is used for other functions. Although the device does inherently involve an electrically resistive effect, the value of the resistance is highly unstable, with typical tolerances of +/−25% or more, and thus cannot be depended on in typical electrical circuits. Further, a device such as the Autopal device also has a very high thermal coefficient of resistance (“TCR”), typically higher than 5000 ppm/° C., which prevents it from being used as a stable power resistor for such functions.

This limitation is particularly significant in the design of automobiles and other motor vehicles, where one consistently complicating factor is the management and use of the limited electrical supply that is typically available on board the vehicle. In an automobile, for instance, the conventional power supply is a 12-volt battery with a limited amount of amperage available. As a result, the benefit of every use of such power must be carefully weighed against the amount of power consumed thereby, and electrical circuits and devices that minimize the overall power consumed are clearly advantageous. Where possible, modern devices are designed to accomplish multiple functions simultaneously without creating a corresponding rise in the amount of power consumed. This may be particularly important for electrical devices that consume particularly large amounts or power. Unfortunately, a dedicated coolant heating device, such as the Autopal device, may not be desirable in many applications because it requires considerable power without serving any other purpose in the vehicle's electrical system. Thus, an efficient device is needed that uses electricity to directly or indirectly heat a motor vehicle's engine when necessary, but can also serve other electrical functions in the vehicle's electrical system, simultaneously or independently, when desired. Preferably, the resistive element of the device will have a relatively low TCR (on the order of hundreds of ppm/° C.) so that the resistance value remains fairly constant during temperature changes. Such an approach could reduce the overall cost of the two functions by combining them into a single device, and when both functions must be carried out simultaneously, such an approach would reduce the overall power consumed by the two or more separate devices.

In particular, it would be advantageous to develop a device that may be used selectively to provide various levels of service with regard to both heating the fluid as well as the unrelated function carried out by the electrical circuit. For example, electric fans are often included in a motor vehicle in order to enhance air cooling of the engine coolant and the like, and are preferably arranged to operate at more than one speed. Similarly, modern automotive headlight systems are often required or preferred to operate both at full brightness as well as a reduced level to carry out a “daytime running lights” function. As with the Autopal device, it would likewise be useful to have an engine heating system that operates at more than one level in order to more accurately control the amount of heat that is provided to the engine. Thus, a need exists for an apparatus and control system that provides all of these functions in an efficient manner using the same assembly.

### SUMMARY OF THE PRESENT INVENTION

The technology of the present invention advances the original concept of putting passive circuits on planar substrates and the concept of stainless steel tubes by incorporating these two technologies and using aluminum as the substrate in a tube form. Advantages include significant weight reduction of the circuit, transferring the generated heat to a circulating transfer fluid, increasing the thermal transfer rate using aluminum versus stainless steel, and creating a network of devices on a single substrate. The fluid involved may be either liquid (such as engine coolant, wiper fluid, and the like) or gas (such as air). Whether the circuit is used as a heater to increase fluid temperature or as a passive device that takes advantage of the thermal mass of the fluid, utilizing the available fluid significantly increases the achievable power density of the device. In effect this creates a smaller device for the defined power in a lightweight product. When this concept is used as an inductor for high frequency switching and filtering, the generated heat is transferred to the fluid, which solves many problems for this type of application.

In addition to the individual uses for this device, another significant advantage is a module that gives a dual use for a thick film on aluminum tube. An example of this is seen in automotive applications where the resistor circuit is used as an engine temperature boost used during warm up and extreme cold environments. Once the engine has come up to temperature, this circuit is switched to the cooling system fans as a means to drop the voltage to the fans thus giving a slower speed option. Another automotive dual use is for switching the heater to a voltage drop resistor for the daytime running lamp function. The present invention may likewise be utilized to heat other fluids commonly present in a motor vehicle, including fuel and wiper fluid.

Broadly defined, the present invention according to one aspect is an automotive electrical circuit assembly, including: an automotive accessory that is electrically operated; a tubular resistor assembly that includes a tubular metal substrate having watertight walls and open ends for connection to an open- or closed-loop fluid-carrying system, and a resistor of a predetermined magnitude, disposed on the tubular metal substrate; and a control circuit, incorporating the resistor, that controls the operation of the automotive accessory.

In features of this aspect, the automotive accessory includes an automotive headlight system; the electrical accessory includes an automotive fan assembly; the tubular metal substrate is aluminum-based; the resistor is a thick film resistor deposited on the tubular metal substrate; the resistor includes a plurality of thick film contacts that electrically connect with the control circuit; and the circuit assembly further includes a fluid flowing through the tubular metal substrate; and the resistor of a predetermined magnitude is a resistor having a predetermined resistive value.

In another aspect, the present invention is a resistive assembly, including: a tubular aluminum-based substrate having watertight walls and open ends for connection to an open- or closed-loop fluid-carrying system; and a thick film resistive element disposed on the outer surfaces of the walls of the tubular aluminum-based substrate.

In features of this aspect, the resistive assembly further includes a control circuit that activates the resistive element; the resistive element includes thick-film contacts that connect to the control circuit; the tubular aluminum-based substrate is part of an automotive heating/cooling system; the tubular aluminum-based substrate is part of a hot water supply system; the tubular aluminum-based substrate is formed from aluminum; the tubular aluminum-based substrate is formed from an aluminum alloy; the thick film resistive element includes pure silver; the thick film resistive element includes a silver-palladium alloy; the thick film resistive element includes ruthenium-oxide; the thick film resistive element includes tantalum nitride; and/or the thick film resistive element includes nickel chromium.

In another aspect, the present invention is a method of manufacturing a tubular resistor assembly, including: providing a section of tubular aluminum; passivating the section of tubular aluminum by applying an anodization layer thereto; and applying a microelectronic thick film material in a predetermined pattern to the anodized section of tubular aluminum.

In features of this aspect, the method further includes, after applying the thick film material, firing the section of tubular aluminum to sinter the thick film material; applying the thick film material includes printing the thick film material onto the anodized section of tubular aluminum; printing the thick film material onto the anodized section of tubular aluminum includes screen printing the thick film material onto the anodized section of tubular aluminum; the method further includes applying a protective layer over the thick film material in order to protect the thick film material from environmental degradation; applying a protective layer includes applying a plastic overmold over the thick film material; and applying a protective layer includes applying a glass over glaze over the thick film material.

In yet another aspect, the present invention is a motor vehicle fluid heating system, including: a tubular resistor assembly that includes a tubular substrate having watertight walls and open ends for connection to an open- or closed-loop fluid-carrying system, and at least two resistive heating elements of predetermined magnitudes, disposed on the tubular substrate, for heating the tubular substrate; and a control circuit for selectively applying power to the two resistive heating elements, wherein the control circuit is operable in a first state to apply power to only one of the resistive heating elements and is operable in a second state to apply power to both of the resistive heating elements, thereby controlling the amount of heat that is applied to the tubular substrate.

In features of this aspect, the automotive fluid heating system further includes an automotive battery for supplying power to the control circuit; the automotive fluid heating system further includes a radiator hose, and the tubular substrate is connected inline with the radiator hose; the automotive fluid heating system further includes a fuel supply line, and the tubular substrate is connected inline with the fuel supply line; the automotive fluid heating system further includes a wiper fluid supply line, and the tubular substrate is connected inline with the wiper fluid supply line; the control circuit is an electronic control module; the at least two resistive heating elements include at least a first resistive heating element of a first predetermined magnitude and a second resistive heating element of a second predetermined magnitude, wherein the first and second predetermined magnitudes are substantially different from one another such that a first amount of heat is applied to the tubular substrate if power is applied only to the first resistive heating element, and a second, substantially different amount of heat is applied to the tubular substrate if power is applied only to the second resistive heating element; and the first and second resistive heating elements of first and second predetermined magnitudes, respectively, are first and second resistors having respective first and second predetermined resistive values.

In another aspect, the present invention is a multi-use motor vehicle fluid heating system, including: a fluid-carrying system; a heating element connected to the fluid-carrying system and arranged to heat fluid carried in the fluid-carrying system; an electrical accessory; and a control circuit for supplying power to the heating element and selectively applying power to the electrical accessory, wherein when power is applied to the electrical accessory, the amount of power supplied to the heating element is reduced, and wherein when power is not applied to the electrical accessory, the amount of power supplied to the heating element is increased.

In features of this aspect, the heating element is a resistive heating element; the resistive heating element is a thick film resistive heating element; the electrical accessory includes a motor vehicle headlight system; and/or the electrical accessory includes a fan; the fluid-carrying system is an open-loop fluid-carrying system; and/or the fluid-carrying system is a closed-loop fluid-carrying system.

In still another aspect, the present invention is a multi-use motor vehicle fluid heating system, including: a fluid-carrying system; a heating element connected to the fluid-carrying system and arranged to heat fluid carried in the fluid-carrying system; an electrical accessory; and a control circuit for supplying power to the electrical assembly and selectively applying power to the heating element, wherein when power is applied to the heating element, the amount of power supplied to the electrical accessory is reduced, and wherein when power is not applied to the heating element, the amount of power supplied to the electrical accessory is increased.

In features of this aspect, the heating element is a resistive heating element; the resistive heating element is a thick film resistive heating element; the electrical accessory includes a motor vehicle headlight system; the electrical accessory includes a fan; the fluid-carrying system is an open-loop fluid-carrying system; and/or the fluid-carrying system is a closed-loop fluid-carrying system.

In another aspect, the present invention is an automotive assembly, including: a fluid-carrying system; a tubular resistor assembly that includes a tubular substrate having watertight walls and open ends, wherein at least one end is in fluid connection with the fluid-carrying system, and a resistive heating element formed from a thick film material disposed on the tubular substrate, for heating the tubular substrate; a control circuit for applying power to the resistive heating element; and an automotive battery for supplying power to the control circuit.

In features of this aspect, the fluid-carrying system is selected from the group consisting of an engine coolant system, a fuel supply system, and a wiper fluid supply system; the tubular substrate is formed from a metal material; the tubular substrate is formed from an aluminum-based material; the tubular substrate is formed from a steel alloy; the fluid-carrying system is an open-loop fluid-carrying system; and/or the fluid-carrying system is a closed-loop fluid-carrying system.

In yet another aspect, the present invention is a control circuit in a motor vehicle having a battery, a headlight system, a fan assembly and a fluid-carrying system, including: a first resistor assembly, arranged to transfer heat generated thereby to a fluid flowing through the fluid-carrying system; a second resistor assembly, arranged to transfer heat generated thereby to the fluid flowing through the fluid-carrying system; a first switching network for supplying power from the battery to the first resistor assembly and for selectively coupling the first resistor assembly to the headlight system; and a second switching network for supplying power from the battery to the second resistor assembly and for selectively coupling the second resistor assembly to the fan assembly.

In features of this aspect, the amount of heat generated at the first resistor assembly when the first resistor assembly is not coupled to the headlight system is substantially different from the amount of heat generated at the second resistor assembly when the second resistor assembly is not coupled to the fan assembly; the amount of heat generated at the first resistor assembly when the first resistor assembly is not coupled to the headlight system is about half as much as the amount of heat generated at the second resistor assembly when the second resistor assembly is not coupled to the fan assembly; the first and second resistor assemblies each include a resistive heating element disposed on a substrate, and the substrate is arranged relative to the fluid-carrying system such that fluid flowing in the fluid-carrying system flows across the substrate, thereby facilitating the transfer of heat from the resistive heating element to the fluid; and each resistive heating element is disposed on a tubular substrate.

In another aspect, the present invention is a method of operating a motor vehicle having an engine and a fan assembly, including: providing means for starting the engine of the motor vehicle; in response to the engine being started, activating an engine temperature control system; and while the engine temperature control system remains active, repeatedly carrying out the functions of monitoring the temperature of the engine, if the temperature of the engine is below a first predetermined level, activating an electrical device for heating a coolant fluid flowing to the engine, thereby transferring heat to the engine, and if the temperature of the engine is above a second predetermined level, wherein the second predetermined temperature level is higher than the first predetermined temperature level, electrically connecting the electrical device to the fan assembly, thereby causing the fan assembly to operate at a lower speed.

In features of this aspect, activating the electrical device includes activating a resistive element; activating the resistive element includes activating a resistive element arranged on a tubular assembly through which the cooling fluid flows; activating the resistive element includes activating a thick film resistive element; and in addition to monitoring the engine temperature, activating the resistive element if the temperature of the engine is below a first predetermined level and electrically connecting the electrical device to the fan assembly if the temperature of the engine is above a second predetermined level, all while the engine temperature control system remains active, the method includes repeatedly carrying out the function of electrically disconnecting the electrical device from the fan assembly, thereby causing the fan assembly to operate at a higher speed, if the temperature of the engine is above a third predetermined level, wherein the third predetermined temperature level is higher than the second predetermined temperature level.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is a perspective view of a tube assembly according to a first preferred embodiment of the present invention;

FIG. 2 is a side view of the tube assembly of FIG. 1;

FIG. 3 is a different side view of the tube assembly of FIG. 1;

FIG. 4 is a planar view of the physical layout of the resistor matrix of FIGS. 2 and 3;

FIG. 5 is a schematic diagram of a typical automobile, illustrating some basic components thereof;

FIG. 6 is a schematic diagram of a simple exemplary circuit employing the tube assembly of FIG. 1;

FIG. 7 is a side view of a tube assembly according to a second preferred embodiment of the present invention;

FIG. 8 is a different side view of the tube assembly of FIG. 7;

FIG. 9 is a planar view of the physical layout of the resistor matrix of FIGS. 7 and 8;

FIG. 10 is a schematic diagram of an exemplary circuit employing the tube assembly of FIG. 7, wherein the lamps of the headlight system and the fan are both off;

FIG. 11 is a schematic diagram of an exemplary circuit employing the tube assembly of FIG. 7, wherein the lamps of the headlight system and the fan are off but maximum heat is being generated and transferred to the coolant in the tube assembly;

FIG. 12 is a schematic diagram of an exemplary circuit employing the tube assembly of FIG. 7, wherein the lamps of the headlight system are operated as daytime running lights and the fan is operated at a low speed; and

FIG. 13 is a schematic diagram of an exemplary circuit employing the tube assembly of FIG. 7, wherein the lamps of the headlight system are operated as standard headlights and the fan is operated at a high speed.

### DETAILED DESCRIPTION OF THE PREFERRED EMBODIMENTS

Referring now to the drawings, in which like numerals represent like components throughout the several views, the preferred embodiments of the present invention are next described. The following description of the preferred embodiments is merely exemplary in nature and is in no way intended to limit the invention, its application, or uses.

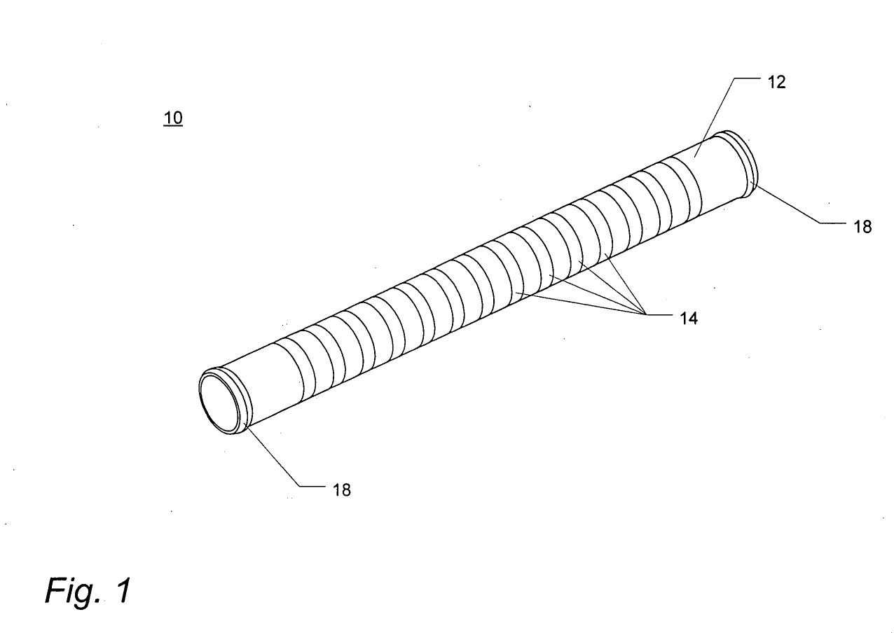

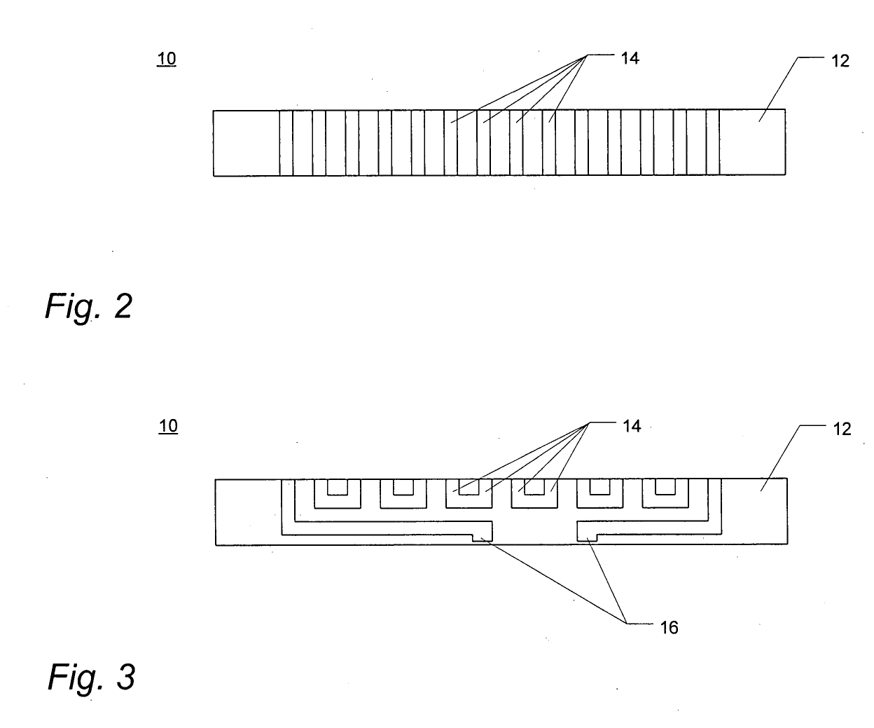

FIG. 1 is a perspective view of a tube assembly 10 according to a first preferred embodiment of the present invention, and FIGS. 2 and 3 are side views of the tube assembly 10 of FIG. 1. The tube assembly 10 includes a tubular substrate 12 having open ends, a resistor matrix 14, a plurality of contacts or contact areas 16 and a pair of flanges 18 of a conventional type for facilitating connection of the tube assembly 10 to other tubular structures and the like. The tubular substrate 12 is formed from a watertight metal tube arranged to conduct water, air or other fluids therethrough. The tubular substrate 12 is preferably formed from a lightweight, inexpensive metal such as aluminum, but in some embodiments other metals, including steel, may instead be substituted. The lighter weight of the aluminum is particularly important in automotive applications where the overall weight of a vehicle is an important design consideration. The tubular substrate 12 may be passivated in order to prepare the surface for the application of the film. Tubular substrates 12 formed from aluminum may be passivated with an anodization layer which covers the entire surface of the tube, both inside and outside. On the other hand, for tubular substrates 12 formed from steel, it may be preferable to print a dielectric layer only in the area of the resistor matrix 14 and contacts 16.

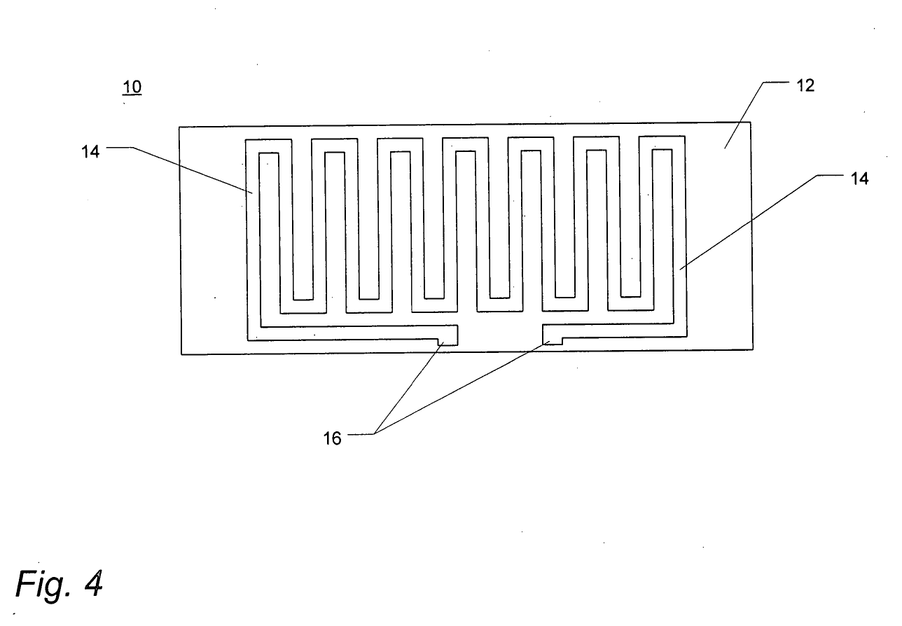

FIG. 4 is a planar view of the physical layout of the resistor matrix 14 of FIGS. 2 and 3. The resistor matrix 14 may be formed from conventional resistive materials, and is preferably applied to the tubular substrate 12 in traces using thick film application techniques such as screen printing, as described previously. The specific material or materials chosen may be dependent upon the Ohmic value or values desired for the resultant resistors, power density considerations, or the like. For applications requiring resistances with low Ohmic values, preferred materials may include pure Ag or Ag/Pd alloys, while for higher Ohmic values, preferred materials may include RuO₃, TaN, NiCr or the like, and may include small amounts of additives in order to adjust the resistance value created thereby. However, a wide variety of other factors may likewise be considered, including the firing profile, power density, noble vs. non-noble elements, ceramic or glass biased, or the like. Many different companies formulate thick film materials, and each combination is optimized for the given application. Thus, it should be apparent that any suitable microelectronic thick film material system may be utilized without departing from the scope of the present invention.

Once the thick film material or materials have been applied, the entire structure may then be fired in order to sinter the thick film materials. Conventional firing temperatures and procedures may be used, selected according to the specific materials used.

As is well known, screen printing thick film application techniques may be used to form multiple material layers on top of each other, but this may not be necessary if the tubular substrate 12 is formed from aluminum and only a single resistor matrix 14 is necessary. The finished matrix 14 may then be covered with a protective glaze or other coating (not shown) to prevent degradation of the material from environmental exposure. In harsh environments such as the engine compartment of a motor vehicle or the like, then a plastic overmold may be preferable. However, for environments that are less harsh, a glass over glaze may be more appropriate. The selection of a coating will be within the skill of one of ordinary skill in the art.

In addition, with regard to certain aspects of the present invention, a suitable resistor matrix 14 of the present invention may likewise be created using thin-film (deposit and etch) and other techniques, and using materials selected to correspond to the selected application process. However, it is anticipated that thin film application processes may be more expensive than thick film application processes. Further, traces created using traditional thin film materials would have to be considerably broader than those created using thick film materials in order to draw the same amount of current, and for many applications, the currents involved would make such dimensions somewhat impractical.

The resistor matrix 14 operates as an electrical resistance when an electrical current is applied to the contacts 16. The thick film-on-aluminum construction provides TCR's that are typically less than 200 ppm/° C., thus minimizing resistance shift due to temperature. Instead, the magnitude of the resistance is primarily dependent upon the material used and the dimensions of the path created thereby. By accurately controlling these parameters, a desired resistive value may thereby be created.

The contacts 16 may likewise be formed from thick film materials applied to the tubular substrate 12 in the same way as the resistor matrix 14. The contacts 16 generally serve to provide a suitable area for making physical contact (and thus an electrical connection) between the resistor matrix 14 and an appropriate electrical circuit. To this end, the contacts 16 generally have a larger surface area, with the contacts 16 generally being wider than individual lengths of the resistor matrix 14. In addition, in order to improve the reliability of the electrical connection between the contacts 16 and the corresponding external (off-tube) circuit or circuits, and particularly to increase the current-carrying capacity of one or more of the contacts 16, it may be useful to increase the thickness of the contacts 16 or use a different thick film material relative to the other portions of the resistor matrix 14. These aspects and design choices will be apparent to those of ordinary skill in the art. Electrical connections may then be completed between any contact 16 and the corresponding circuit via a soldered joint, a mechanical pressure contact, the connection method and apparatus disclosed in U.S. Pat. No. 6,530,776to Pilavdzic et al. (the entirety of which is incorporated herein by reference), or the like, the design and implementation of any of which would be apparent to one of ordinary skill in the art.

The tube assembly 10 of FIGS. 1-3 may be used in a wide variety of implementations and applications. As introduced previously, the assembly 10 may be utilized to cool a resistor of a particular magnitude in a control circuit by carrying heat away therefrom, as a resistive heating element for raising the temperature of a fluid flowing through the tubular substrate 12, or in certain circumstances, both at the same time. These various functions and how they work together or separately will be further discussed hereinbelow.

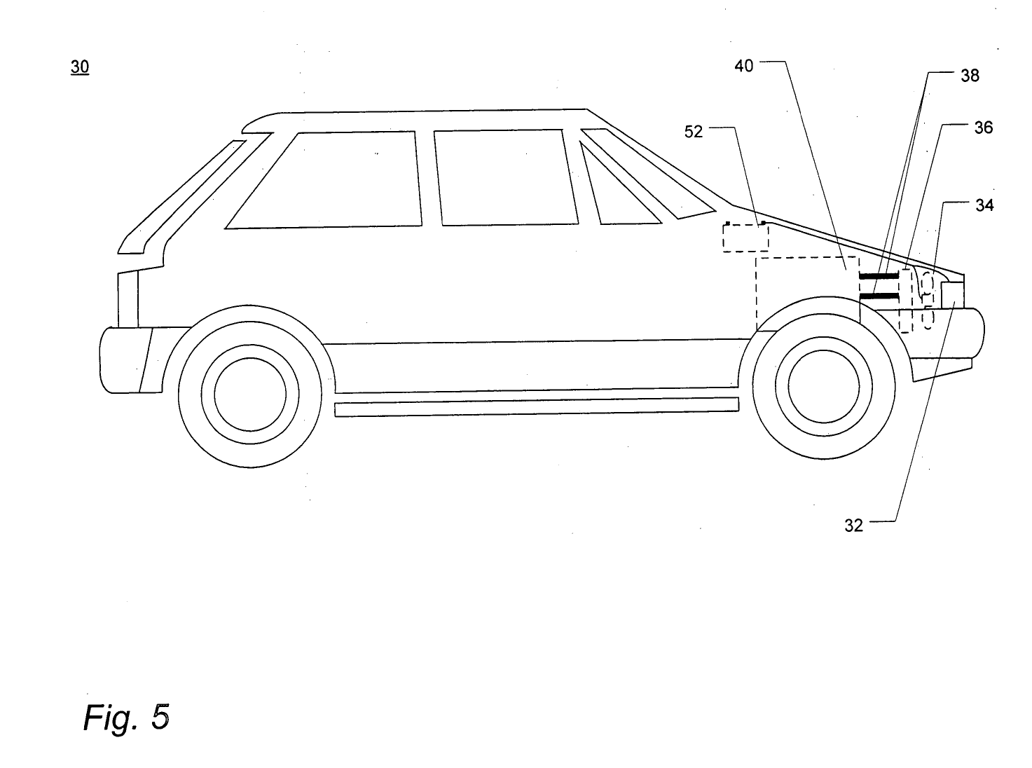

One particularly useful application for the tube assembly 10 of the present invention is as an electrical circuit assembly in the context of an automobile 30 or another motor vehicle, particularly one using an engine 40 or other motor that is water-cooled. FIG. 5 is a schematic diagram of a typical automobile 30, illustrating some basic components thereof As shown therein, such a vehicle 30 typically includes an engine 40, a radiator 36 connected via hoses 38 to the engine 40, a fan 34 for forcing air through and across the radiator 36, and a number of electrical components, including the lamps 32 in a headlight system, and a battery (voltage source) 52 for supplying sufficient electrical power to the fan 34, lamps 32 and the other electrical components.

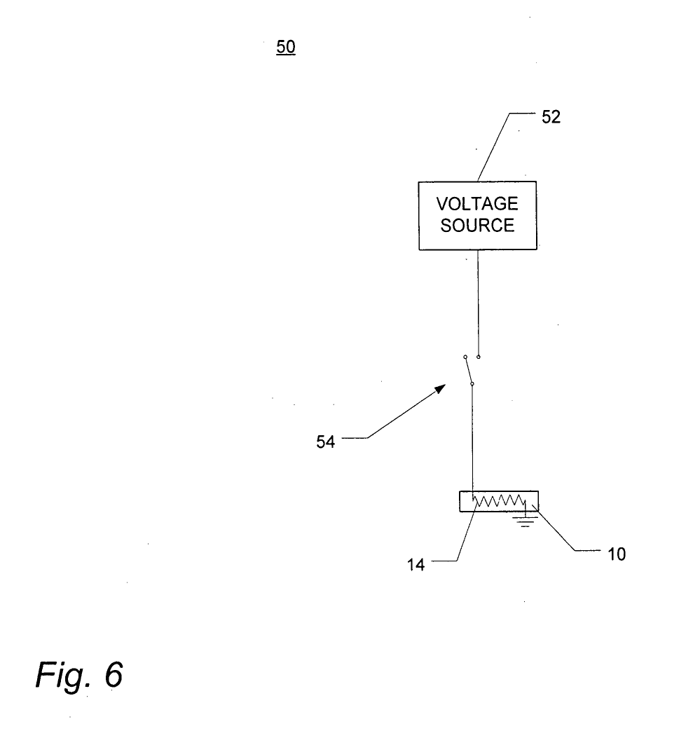

FIG. 6 is a schematic diagram of a simple exemplary circuit 50 employing the tube assembly 10 of FIG. 1. In addition to the tube assembly 10 and its resistor matrix 14, the circuit 50 includes a voltage source 52, such as the car battery described above, and a switch 54. The tube assembly 10 may be disposed inline in a pipe, hose or tube system, such as one of the radiator hoses 38 shown in FIG. 5, having water or another coolant fluid flowing therethrough. The switch 54 may be opened and closed via a relay (not shown) of conventional construction. When the switch 54 is closed, the voltage generated by the voltage source 52 is applied to the resistor matrix 14, causing a current to flow through the circuit 30. As the current passes through the resistor matrix 14, a proportional amount of heat is generated and transferred to the fluid flowing through the tube assembly 10. Thus, when the resistor matrix 14 is being used as a resistor of a specific value in an electrical circuit 50, the heat generated thereby may be dissipated via the flowing fluid.

In addition to serving as a resistor having a predetermined value in an electrical circuit for controlling a particular electrical device, the resistor matrix 14 may also be used to resistively heat a fluid flowing through the tubular substrate 12. For example, automobiles 30 use a variety of fluids, including coolant fluids for the engine 40, wiper fluids to be sprayed on the automobile's windshield, fuel in the form of gasoline or the like, fluid-based seat heating systems, and others. In varying degrees, in may be necessary to warm or heat each such fluid in order to ensure reliable operation of the respective system. In each case, the tube assembly 10 of the present invention may be disposed inline in the pipe, hose or tube system through which the fluid flows, and the resistor matrix 14 may be activated in order to resistively heat the tubular substrate 12. The heat is then transferred to the fluid, and in at least some cases may be further transferred via the fluid to other downstream components of the respective systems.

For example, such a process may be utilized to heat an automobile engine 40 and to boost the available cabin heat. The former may be useful, for example, when the engine 40 is being cold-started in order to heat the engine 40 more quickly, thus facilitating smooth operation, reducing engine wear and maximizing fuel efficiency. The relay referred to previously may be controlled to close the switch 54 when the engine 40 is started and then to reopen it sometime thereafter, once the engine 40 has been warmed to a sufficient level. It will be apparent, however, that the effectiveness of this heat transfer process may be dependent upon where the tube assembly 10 is disposed within the automobile's cooling system. The relay may be controlled via a timer, or one or more temperature sensors (not shown) may be utilized to determine when the engine 40 has warmed to the desired level. If temperature sensors are used, they may also be used to determine whether the engine 40 is cold enough to warrant use of the described process at all. The process could find further applicability in extremely cold climates, where supplemental heating may be necessary merely to keep the coolant from congealing or even freezing, and will act to boost the cabin temperature more quickly by warming the engine 40 more quickly. The same temperature sensors could be utilized to activate the described process for as long as the ambient temperature remains cold enough to warrant it.

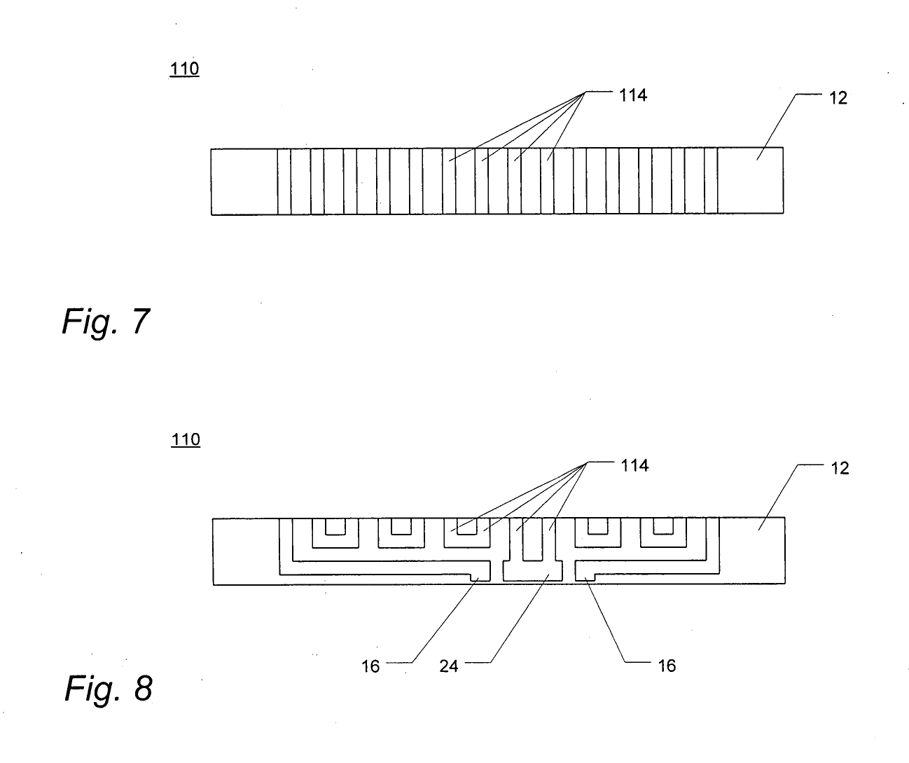

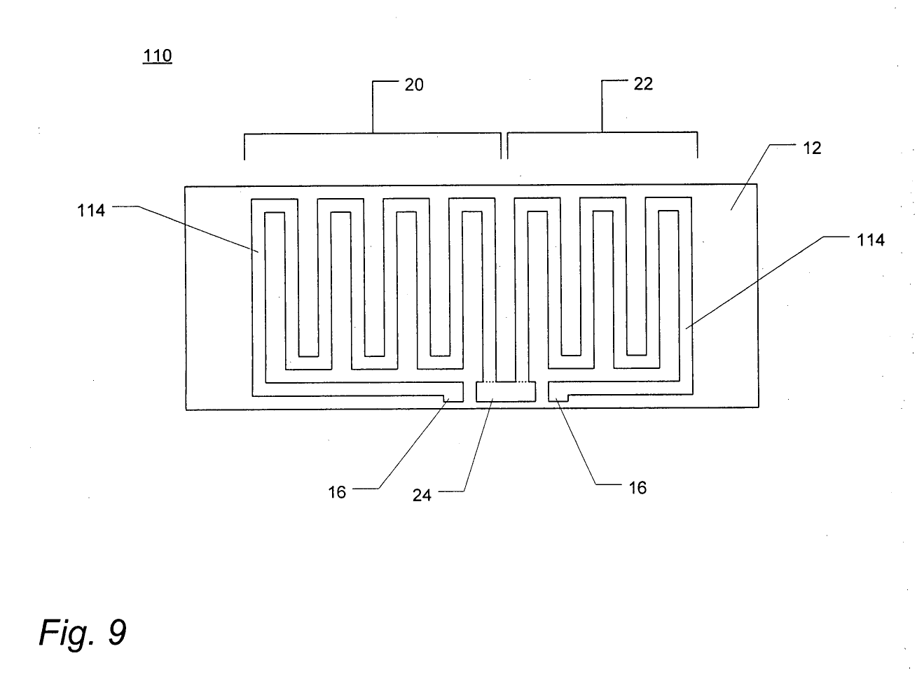

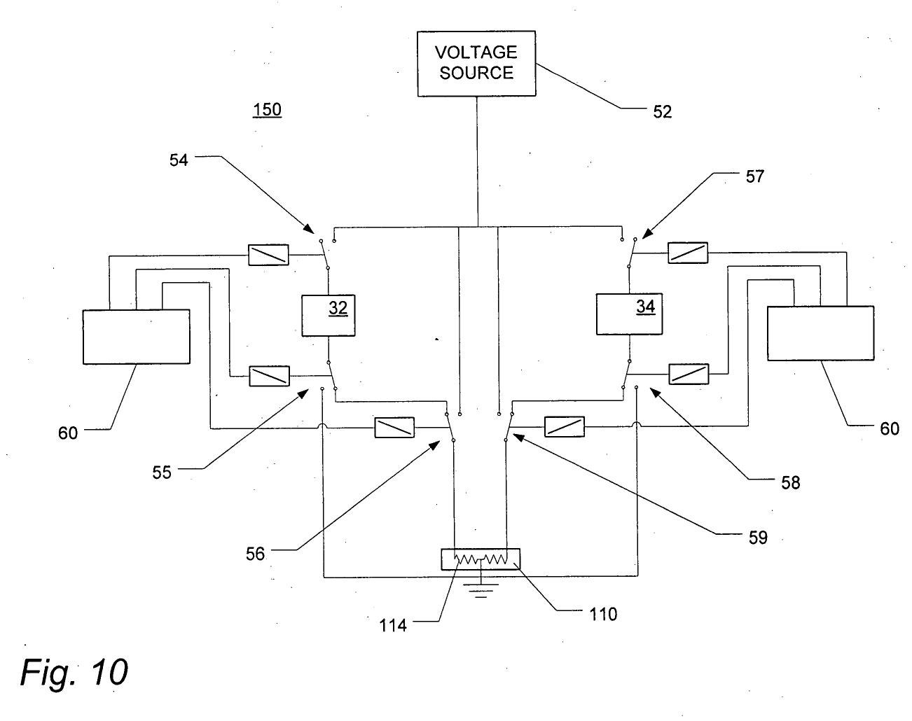

A wide variety of more complicated and flexible control systems are likewise possible using this same technology. For example, FIGS. 7 and 8 are side views of a tube assembly 110 according to a second preferred embodiment of the present invention, and FIG. 9 is a planar view of the physical layout of the resistor matrix 114 of FIGS. 7 and 8. As with the first preferred tube assembly 10, the second tube assembly 110 includes a tubular substrate 12, a resistor matrix 114 and a plurality of contacts 16. The tubular substrate 12, resistor matrix 114 and contacts 16 may be of similar construction to that of the first tube assembly 10. However, the second tube assembly 110 further includes one or more common contacts 24, which may serve as common ground points, and the layout of the resistor matrix 114 in the second embodiment differs from that of the first. For example, as best illustrated in FIG. 9, a common ground point 24 physically partitions the resistor matrix 114 into at least two zones 20, 22, as illustrated in FIGS. 10-13. Each zone 20, 22 may then be used independently of the other, as described hereinbelow.

As with the first preferred embodiment of the tube assembly 10, a particularly useful implementation of the second tube assembly 110 may be in an automobile 30 or other motor vehicle. With reference once again to the schematic diagram of FIG. 5, the second tube assembly 110 may be used, for example, to provide electrical power, at the right voltage levels, to the lamps 32 of the headlight system as well as to the fan 34. FIGS. 10-13 are schematic diagrams of an exemplary circuit 150 employing the tube assembly 110 of FIG. 7. The circuit 150 includes the tube assembly 110 of the second preferred embodiment, one or more controllers 60, a plurality of switches 54, 55, 56, 57, 58, 59, and the battery or other voltage source 52, as well as the lamps 32 of the headlight system and the fan 34. Of course, although two controllers 60 are illustrated in FIGS. 10-13, it should be apparent that the two separate controllers 60 may instead be replaced by a single device, such as the device known variously as the automobile's electronic engine control (“EEC”) module, the engine control module (“ECM”), or the like.

FIG. 10 is a schematic diagram of the circuit 150 employing the tube assembly 110 of FIG. 7, wherein the lamps 32 of the headlight system and the fan 34 are both off Under the control of the controllers or EEC module 60, the first, third, fourth and sixth switches 54, 56, 57, 59 are all opened, thus deactivating the entire circuit 150. As a result, no current is applied to either zone 20, 22 of the resistor matrix 114 of the tube assembly 110, and thus no heat is generated. This may be the typical state of the circuit 150 when the automobile 30 is inactive (i.e., when its ignition is turned off).

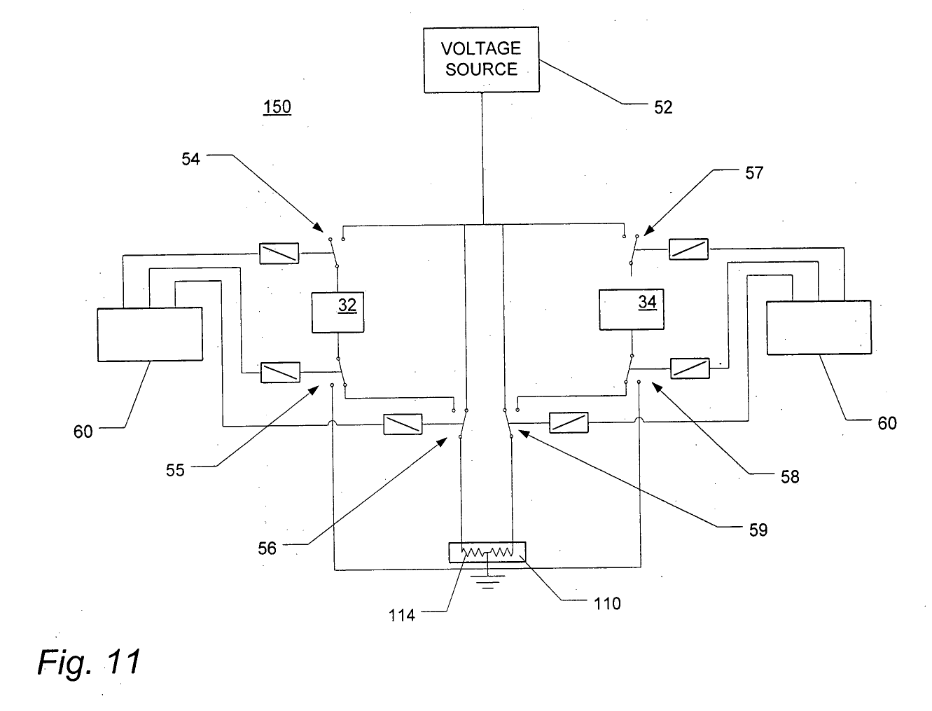

FIG. 11 is a schematic diagram of a circuit 150 employing the tube assembly 110 of FIG. 7, wherein the lamps 32 of the headlight system and the fan 34 are off but maximum heat is being generated and transferred to the coolant in the tube assembly 110. Under the control of the controllers or EEC module 60, the third and sixth switches 56, 59 are both closed, thus applying the full voltage directly to each of the two zones 20, 22 of the resistor matrix 114 of the tube assembly 110. Power in the form of heat is generated in a first portion of the tube assembly 110 at a rate that is inversely proportional to the resistive value of the first zone 20 of the resistor matrix 114, and is simultaneously generated in a second portion of the tube assembly 110 at a rate that is inversely proportional to the resistive value of the second zone 22 of the resistor matrix 114.

For example, if the voltage source supplies 14 VDC, the resistive value of the first zone 20 of the resistor matrix 114 is 660 mΩ and the resistive value of the second zone 22 of the resistor matrix 114 is 330 mΩ, then 300 W of heat would be generated in the first portion of the tube assembly 110 and 600 W of heat would be generated in the second portion of the tube assembly 110. Much of the combined 900 W of heat would then be transferred via the tubular substrate 12 to the coolant flowing therethrough and carried to the engine 40, where it would tend to dissipate. As described previously, such a process could be used to intentionally heat the engine 40 such as, for example, during a “cold start” thereof Of course, although not separately illustrated, it should be apparent that more limited quantities of engine heating could be produced by controlling the third and sixth switches 56, 59 to activate only one or the other of the zones 20, 22 of the tube assembly 110. If, as in the example above, the two zones 20, 22 of the resistor matrix 114 have two significantly different resistive values, then three different heating levels (300 W, 600 W and 900 W) could be produced, depending upon how much heat is desired by controlling the switches 56, 59 appropriately. One or more temperature sensors (not shown) could further be utilized to trigger operation of the controllers or EEC module 60 and to control how much heat is to be applied to the engine 40.

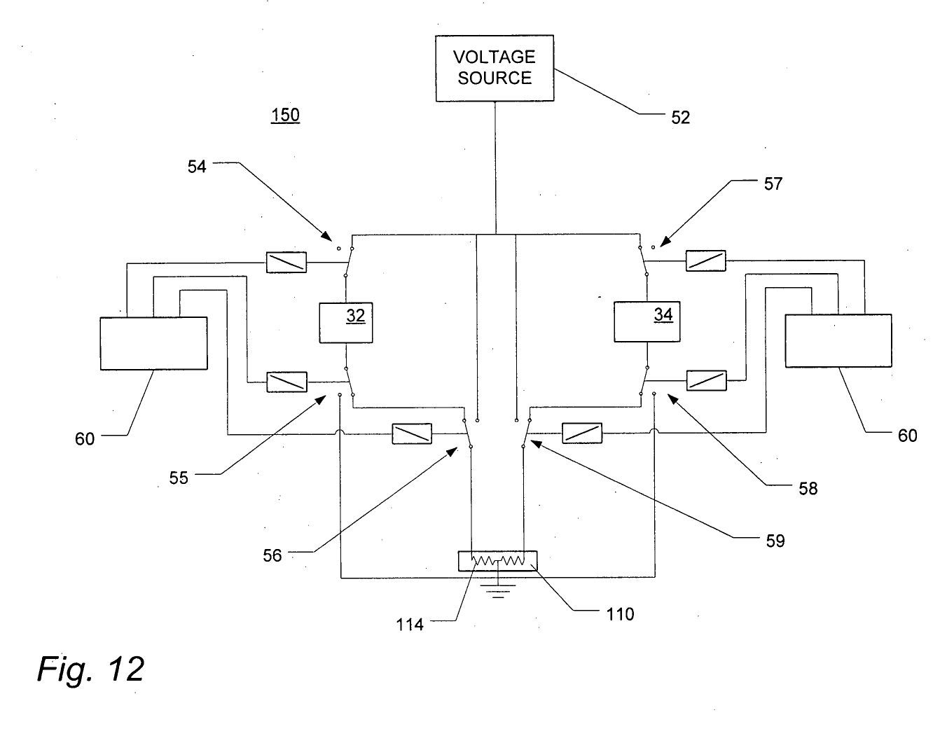

FIG. 12 is a schematic diagram of a circuit 150 employing the tube assembly 110 of FIG. 7, wherein the lamps 32 of the headlight system are operated as daytime running lights and the fan 34 is operated at a low speed. Under the control of the controllers or EEC module 60, the first and fourth switches 54, 57 are closed, the third and sixth switches 56, 59 are opened, and the second and fifth switches 55, 58 are adjusted to connect the lamps 32 and fan 34 to the first and second zones 20, 22, respectively, of the resistor matrix 114. In this state, the voltage supplied by the voltage source 52 is applied across the lamps 32 and the first zone 20 of the resistor matrix 114 in series, and also applied across the fan 34 and the second zone 22 of the resistor matrix 114 in series. The resulting voltage differentials across the lamps 32 and fan 34, respectively, are less than the full voltage, and thus the lamps 32 and fan 34 are each operated at a reduced voltage. In the case of the lamps 32, this has the effect of creating dimmer headlights than normal, which may be used as daytime running lights, while in the case of the fan 34, this has the effect of operating the fan 34 at the lower of two fan speeds. In addition, a relatively small amount of heat is transferred to the coolant via the respective zones 20, 22 of the resistor matrix 114.

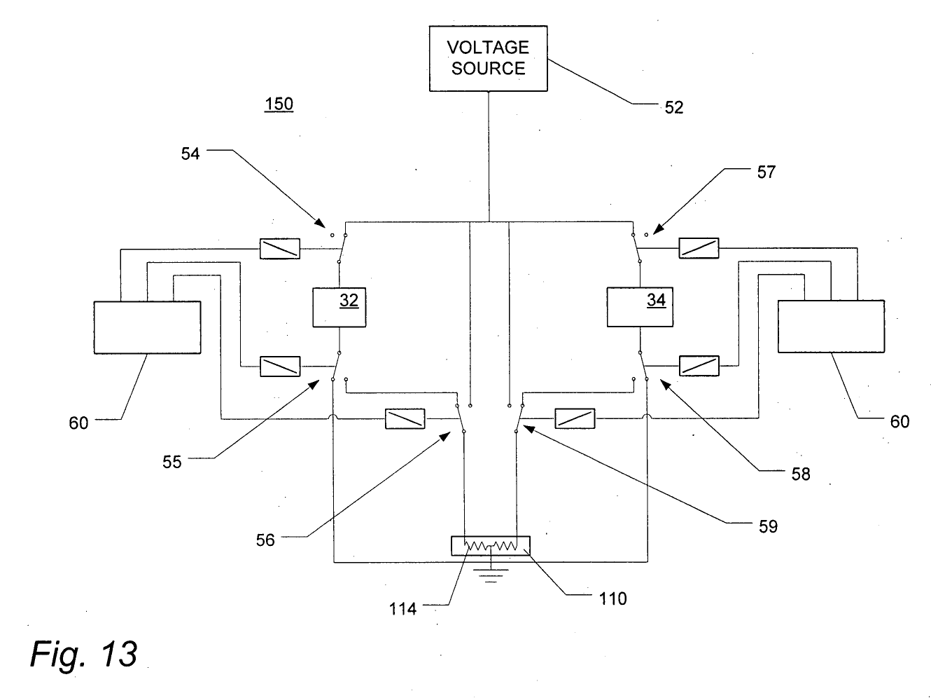

FIG. 13 is a schematic diagram of a circuit 150 employing the tube assembly 110 of FIG. 7, wherein the lamps 32 of the headlight system are operated as standard headlights and the fan 34 is operated at a high speed. Under the control of the EEC modules 60, the first and fourth switches 54, 57 are closed, the third and sixth switches 56, 59 are opened, and the second and fifth switches 55, 58 are adjusted to connect the lamps 32 and fan 34 directly to ground. In this state, the full voltage supplied by the voltage source 52 is applied directly to both the lamps 32 and the fan 34, while the tube assembly 110 is disconnected from the circuit 150. In the case of the lamps 32, this has the effect of operating the headlights at their normal brightness, while in the case of the fan 34, this has the effect of operating the fan 34 at the higher of two fan speeds. In addition, because the tube assembly 110 has been disconnected from the circuit 150, no current is applied to either zone 20, 22 of the resistor matrix 114 of the tube assembly 110, and thus no heat is generated thereby.

As will be apparent to one of ordinary skill in the art, the lamps 32 and fan 34 may be controlled independently from each other via appropriate adjustment or control of the EEC modules 60. In other words, the lamps 32 of the headlight system may be operated as daytime running lights, normal headlights, or not at all, whether or not the fan 34 is operating at a high or low speed, or even operating at all. Similarly, the fan 34 may be operated at a high or low speed, or deactivated completely, regardless of the state of the lamps 32. The operational level of the lamps 32 may be controlled manually or may be triggered by one or more sensors. For example, the lamps 32 may be activated automatically any time the automobile 30 is running (i.e., when the ignition is on), and one or more light sensors (not shown) may be utilized to determine whether to operate the lamps 32 as daytime running lights or normal headlights. Operation of the fan 34 may be controlled by one or more temperature sensors (not shown), with operation at the lower speed triggered when a first threshold temperature is reached, and operation at higher speed triggered when a second, high threshold temperature is reached. Threshold temperatures may be selected according to the requirements of particular fans or the engines and other components that they are designed to cool.

Of course, it will be apparent to those of ordinary skill in the art that the circuits 50, 150 described herein may instead by formed in any conventional manner and on any suitable substrate, including planar substrates and the like. Although such embodiments would not be able to provide the cooling function offered by the tubular embodiments described herein, such circuits may still be useful for carrying out the described functionality, particularly if the heat generated thereby can be managed.

It will also be apparent that a tube assembly similar to those described herein may also be used in a wide variety of other applications. For example, as mentioned previously, the fluid flowing through the tube assembly may be air or another gas. Moreover, the fluid-carrying system in which the tube assembly is utilized may be either a closed-loop or, in some cases, an open-loop system, particularly if the fluid used is air. The fluid may-be forced through the system by a pump, a fan, or by other means, such as using the movement of the vehicle in which it is mounted to force air through the system via an air intake. Further, the tube assembly and other aspects of the present invention will find applicability not only in cars and trucks, but in many other vehicles as well, including yachts, recreational vehicles, boats, and the like.

Based on the foregoing information, it is readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to its preferred embodiment, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof Although specific terms are employed herein, they are used in a generic and descriptive sense only and not for the purpose of limitation.

1. (canceled)

2. (canceled)

3. (canceled)

4. (canceled)

5. (canceled)

6. (canceled)

7. (canceled)

8. (canceled)

9. A resistive assembly, comprising:
a tubular aluminum-based substrate having watertight walls and open ends for connection to an open- or closed-loop fluid-carrying system; and
a thick film resistive element disposed on the outer surfaces of the walls of the tubular aluminum-based substrate.

10. The resistive assembly of claim 9, further comprising a control circuit that activates the resistive element.

11. The resistive assembly of claim 10, wherein the resistive element includes thick-film contacts that connect to the control circuit.

12. The resistive assembly of claim 11, wherein the tubular aluminum-based substrate is part of an automotive heating/cooling system.

13. The resistive assembly of claim 11, wherein the tubular aluminum-based substrate is part of a hot water supply system.

14. The resistive assembly of claim 11, wherein the tubular aluminum-based substrate is formed from aluminum.

15. The resistive assembly of claim 11, wherein the tubular aluminum-based substrate is formed from an aluminum alloy.

16. The resistive assembly of claim 11, wherein the thick film resistive element includes pure silver.

17. The resistive assembly of claim 11, wherein the thick film resistive element includes a silver-palladium alloy.

18. The resistive assembly of claim 11, wherein the thick film resistive element includes ruthenium-oxide.

19. The resistive assembly of claim 11, wherein the thick film resistive element includes tantalum nitride.

20. The resistive assembly of claim 11, wherein the thick film resistive element includes nickel chromium.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)
